(19) United States
(12) Patent Application Publication
(10) Pub. No.: US 2007/0300175 A1
(43) Pub. Date: Dec. 27, 2007

(54) Electronic device and key setting method

(75) Inventor: Chih-Kuo Lu, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION, Taipei (TW)

(21) Appl. No.: 11/710,947

(22) Filed: Feb. 27, 2007

(30) Foreign Application Priority Data
Jun. 23, 2006 (TW) 095122863

(51) Int. Cl. G06F 3/048

(52) U.S. Cl. 715/773

(57) ABSTRACT

A key setting method is used in an electronic device, which has a touch panel. The method includes the following steps. First, a Keyboard format having at least one key is selected. Then, a pattern is set to be displayed on the touch panel corresponding to the key of the Keyboard format. Finally, the settings related to the Keyboard format and the key are stored. In addition, an electronic device, which executes the key setting method, is also disclosed.

### BACKGROUND OF THE INVENTION

1. Field of Invention

The invention relates to an electronic device and, in particular, to an electronic device carrying out a key setting method.

2. Related Art

FIG. 1A shows a conventional electronic device 1 such as a mobile phone. Generally speaking, the electronic device 1 has several character keys 11 and several function keys 12. It further has a key panel 13 imprinted with characters or patterns. A user identifies the functions of all the character keys 11 and the function keys 12 via the key panel 13. The user can thus operate the electronic device 1 by selectively pressing a character key 11 or function key 12.

However, the characters and patterns on the key panel 13 are all fixed. This fixes the appearance of the electronic device 1. If the user wants to change the appearance of the electronic device 1, the original key panel 13 has to be taken off and replaced with another one (not shown). Therefore, it is inconvenient to change the appearance of a conventional electronic device 1 because the key panel 13 has to be replaced. Moreover, an additional key panel would increase the cost of the device.

As touch panel technology develops rapidly, touch panels are beginning to be used in electronic devices. As shown in FIG. 1B, another conventional electronic device 1′ has a touch panel 14 that can display a Keyboard format 141. The Keyboard format 141 has several keys 141a. Thus, the electronic device 1′ is often provided with several operating interfaces. The Keyboard format 141 shown in FIG. 1B is one of them. In other words, when entering different items in the menu of the electronic device 1′ to use different functions thereof, the user uses different operating interfaces for operating the electronic device 1′. In this case, the different operating interfaces displayed by the touch panel 14 can change the appearance of the electronic device 1′.

Nonetheless, the number of operating interfaces in the electronic device 1′ is finite. The user cannot actively set the Keyboard format 141 provided by the operating interface, and thus cannot choose a pattern of keys according to his/her preference. This forbids the electronic device 1′ from having personalized styles, versatility and amusement value.

Consequently, it is highly desirable to provide an electronic device allowing the user to select a Keyboard format and change key patterns.

### SUMMARY OF THE INVENTION

In view of the foregoing, the invention is to provide an electronic device and a key setting method that enable the user to select a Keyboard format and design key patterns.

To achieve the above, the invention discloses a key setting method used in an electronic device, which has a touch panel. The method includes the following steps. First, a Keyboard format having at least one key is selected. Then, a pattern is set to be displayed on the touch panel corresponding to the key of the Keyboard format. Finally, the settings related to the Keyboard format and the key are stored.

In addition, the invention discloses an electronic device, which includes a touch panel, a Keyboard format selecting module, a key pattern setting module and a storing module. The Keyboard format selecting module provides a plurality of options of different Keyboard formats to be selected via the touch panel. Each of the Keyboard formats has at least one key. The key pattern setting module provides a plurality of options of different patterns to be selected corresponding to the key in the Keyboard format via the touch panel. The storing module stores settings related to the Keyboard format and the key.

As mentioned above, the electronic device and the key setting method of the invention have a Keyboard format selecting module and a key pattern setting module. Via the touch panel, the user can set the Keyboard format and key patterns according to his or her desire by following a specific procedure. Compared with the prior art, the invention indeed has more variety and amusement value and can display a personalized style.

### BRIEF DESCRIPTION OF THE DRAWINGS

The invention will become more fully understood from the detailed description given herein below illustration only, and thus is not limitative of the present invention, and wherein:

FIG. 1A is a schematic view of a conventional electronic device;

FIG. 1B is a schematic view of another conventional electronic device;

FIG. 2 is a block diagram of an electronic device according to an embodiment of the invention;

FIG. 3 is a schematic view of an electronic device according to the embodiment of the invention;

FIG. 4 is a schematic view of the electronic device, showing that the Keyboard format selecting module provides several Keyboard formats for selection;

FIG. 5 is a schematic view of the electronic device with a numeral Keyboard format;

FIG. 6 is a schematic view of the electronic device, showing the key pattern setting module selecting a texture pattern aspect for the key b1;

FIG. 7 is a schematic view of the electronic device, showing the key pattern setting module selecting a picture aspect for the key b2;

FIG. 8 is a schematic view of the electronic device, showing the key pattern setting module selecting a texture pattern aspect for the keys b;

FIG. 9 is a schematic view of the electronic device, showing the storing module storing the Keyboard format and key related settings; and

FIG. 10 is a flowchart showing a key setting method according to an embodiment of the invention.

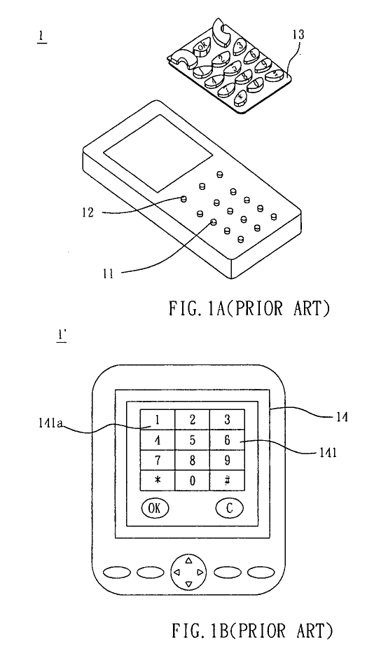

### DETAILED DESCRIPTION OF THE INVENTION

The present invention will be apparent from the following detailed description, which proceeds with reference to the accompanying drawings, wherein the same references relate to the same elements.

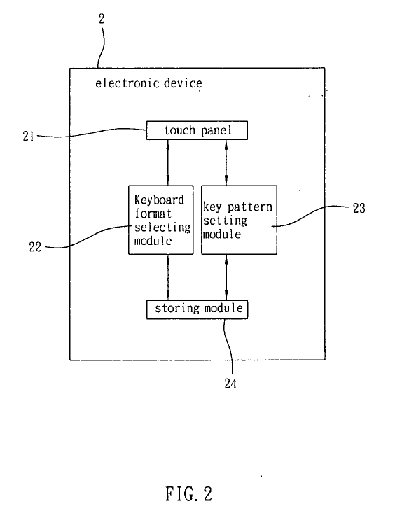

As shown in FIG. 2, an electronic device 2 according to an embodiment of the invention is a mobile phone. However, the electronic device 2 of the invention can be any other portable electronic device 2, such as a personal digital assistant (PDA), smart phone, or tablet computer. In this embodiment, the electronic device 2 includes a touch panel 21, a Keyboard format selecting module 22, a key pattern setting module 23, and a storing module 24.

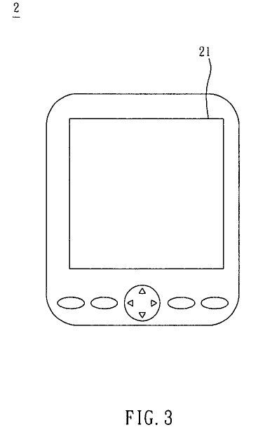

Please refer simultaneously to FIGS. 2 and 3. The touch panel 21 can be a resistor-type touch panel, a capacitor-type touch panel, or a wave-type touch panel.

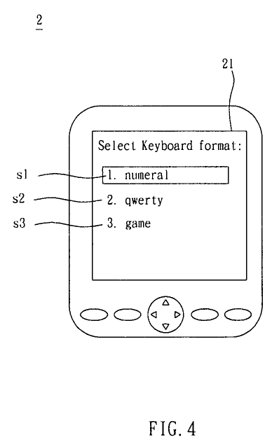

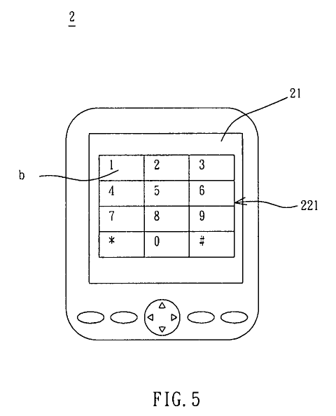

As shown in FIGS. 2, 4, and 5, the Keyboard format selecting module 22 displays several options s1 to s3 corresponding to several Keyboard formats 221 on the touch panel 21 for the user to select one of the Keyboard formats 221. Each Keyboard format 221 has at least one key b. Generally speaking, the electronic device 2 usually first enters a key setting mode in order for the touch panel 21 to display the options s1 to s3 of the Keyboard formats provided by the Keyboard format selecting module 22 (as shown in FIG. 4). In this embodiment, the Keyboard format selecting module 22 provides a numeral Keyboard format option s1, a qwerty Keyboard format option s2, and a game Keyboard format option s3. FIG. 5 shows an example of the embodiment in which the numeral Keyboard format option s1 is selected. The numeral Keyboard format 221 has 12 keys b. Of course, the Keyboard format selecting module 22 can also provide options for other types of numeral Keyboard formats, character Keyboard formats, direction Keyboard formats, game Keyboard formats, calculator Keyboard formats, or compound Keyboard formats.

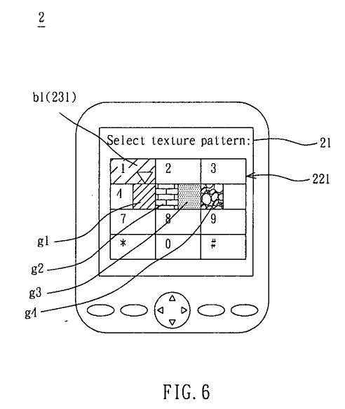

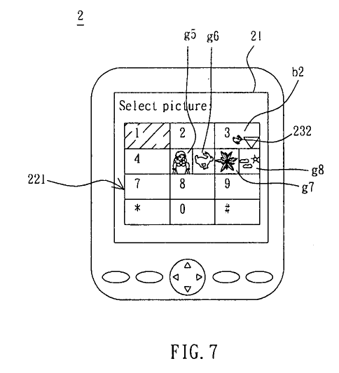

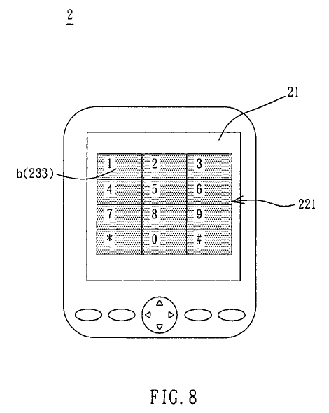

With reference to FIGS. 2, 6, and 7, the key pattern setting module 23 displays several options g1 to g4 of patterns for the keys b on the Keyboard format 221 via the touch panel 21 for the user to select one of the patterns. As shown in FIG. 6, the touch panel 21 displays several options g1 to g4 of texture patterns for the keys b on the Keyboard format 221 so that the user may select a texture pattern via the touch panel 21. For example, the texture pattern option can be a stripe option g1, a grid option g2, a mesh option g3, a figure option g4, and other regular or irregular texture options. In this embodiment, the user clicks the touch panel 21 to select the stripe option g1, so that one key b1 of the Keyboard format 221 has a stripe texture 231. Furthermore, the touch panel 21 may display several options (not shown) of color patterns corresponding to the key b on the Keyboard format 221 for the user to select one of the color patterns. Therefore, the color of the key b can be set preferred by the user. As shown in FIG. 7, the touch panel 21 displays several options g5 to g8 of pictures corresponding to the keys b on the Keyboard format 221 for the user to select a picture via the touch panel 21. For example, the picture option may be a human picture option g5, an animal picture option g6, a plant picture option g7, a nature picture option g8, and other appropriate picture options. It should be mentioned that the picture selected can be directly used as the background or picture of the keys b. In this embodiment, the animal picture option g6 is selected, so that the animal picture 232 is used as the picture corresponding to another key b2 in the Keyboard format 221. Additionally, in FIGS. 6 and 7, the texture pattern 231 corresponding to the key b1 and the picture 232 of the key b2 is set. Of course, the pattern for all keys b of the Keyboard format 221 can be simultaneously set. As shown in FIG. 8, the mesh option g3 is selected, so that the keys b have the selected meshed texture 233.

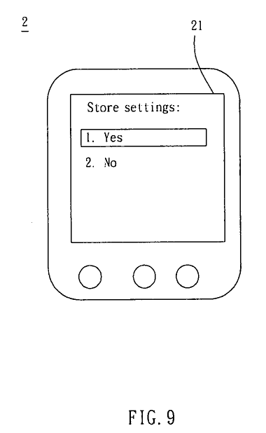

As shown in FIG. 9, the storing module 24 stores the settings related to the Keyboard format 221 and the keys b. In this embodiment, the storing module 24 stores the Keyboard format 221 (numeral keyboard) selected by the Keyboard format selecting module 22 and the key pattern (texture pattern, color, and pictures) selected using the key pattern setting module 23.

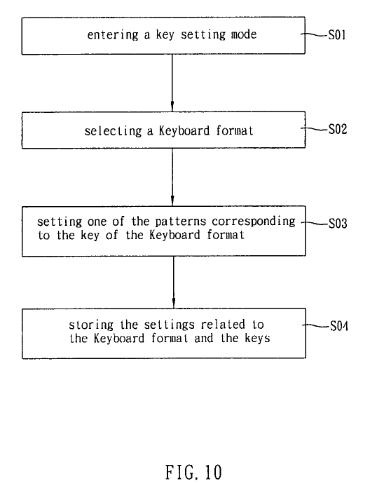

FIG. 10 shows a flowchart of a key setting method according to an embodiment of the invention. In the following, the flowchart is used to explain steps S01 to S04 when the disclosed key setting method is applied to the above-mentioned electronic device 2.

First, step S01 is to enter a key setting mode to select a Keyboard format 221. In this embodiment, after the electronic device 2 enters the key setting mode, the touch panel 21 displays several options s1 to s3 of Keyboard formats provided by the Keyboard format selecting module 22. Therefore, the user can click the touch panel 21 to select a Keyboard format 221.

In step S02, a Keyboard format 221, which has at least one key b, is selected. As shown in FIG. 4, the touch panel 21 displays three Keyboard format options s1 to s3 provided by the Keyboard format selecting module 22. They are a numeral Keyboard format option s1, a qwerty Keyboard format option s2, and a game Keyboard format option s3. In this embodiment, the user clicks the touch panel 21 to enable the Keyboard format selecting module 22 to select the numeral Keyboard format option s1. As shown in FIG. 5, the touch panel 21 displays a numeral Keyboard format 221 having twelve keys b.

In step S03, one of the patterns is set and displayed on the touch panel 21 corresponding to the key b of the Keyboard format 221. In this embodiment, step S03 includes the step of setting a texture pattern 231 corresponding to the key b1. As shown in FIG. 6, the touch panel 21 displays several texture pattern options g1 to g4 provided by the key pattern setting module 23. The user clicks the touch panel 21 to select one texture option g1 for the texture pattern 231 corresponding to the key b1. As shown in FIG. 7, step S03 includes the step of setting a picture 232 corresponding to the key b2. The touch panel 21 displays several picture options g5 to g8 provided by the key pattern setting module 23. The user clicks the touch panel 21 to select an animal picture option g6 for the picture 232 corresponding to the key b2. Moreover, step S03 includes the step of setting a color pattern displayed on the touch panel 21 corresponding to the key. The touch panel 21 further displays several color pattern options (not shown) provided by the key pattern setting module 23. The user can click the touch panel 21 to select a color pattern corresponding to the keys b in the Keyboard format 221. Of course, the user can simultaneously change the patterns of all the keys b in the keyboard format 221. As shown in FIG. 8, the user selects a mesh option g3 for the texture pattern 233 of all keys b. Therefore, the user can use the key pattern setting module 23 to define the texture pattern 231, picture 232 or color pattern displayed on the touch panel 21 corresponding to the keys in the Keyboard format 221, enriching the patterns of the Keyboard format 221.

Finally, in step S04, the settings related to the Keyboard format 221 and the keys b are stored. As shown in FIG. 9, the touch panel 21 displays two options 241, 242, representing “Yes” and “No” respectively. When the user selects the option of “Yes” 241, the storing module 24 is enabled to store the Keyboard format 221 (numeral keyboard) selected with the Keyboard format selecting module 22, and the key patterns 231, 232 (texture pattern, color pattern, and picture) selected with the key pattern setting module 23. On the other hand, if the user selects the option of “No” 242, the storing module 24 does not store the settings related to the Keyboard format 221 and the keys b.

In summary, the electronic device and the key setting method of the invention have a Keyboard format selecting module and a key pattern setting module. Via the touch panel, the user can set the Keyboard format and key patterns according to his or her desire by following a specific procedure. Compared with the prior art, the invention indeed has more variety and amusement value and can display a personalized style.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A key setting method used in an electronic device having a touch panel, the method comprising steps of:
selecting a Keyboard format having at least one key;
setting a pattern displayed on the touch panel corresponding to the key of the Keyboard format; and
storing settings related to the Keyboard format and the key.

2. The key setting method of claim 1, wherein the Keyboard format is a numeral Keyboard format, a character Keyboard format, a direction Keyboard format, a game Keyboard format, a calculator Keyboard format, or a compound Keyboard format.

3. The key setting method of claim 1, wherein the step of setting a pattern displayed on the touch panel corresponding to the key of the Keyboard format comprises:
setting a texture pattern displayed on the touch panel corresponding to the key of the Keyboard format.

4. The key setting method of claim 1, wherein the step of setting a pattern displayed on the touch panel corresponding to the key of the Keyboard format comprises:
setting a color pattern displayed on the touch panel corresponding to the key of the Keyboard format.

5. The key setting method of claim 1, wherein the step of setting a pattern displayed on the touch panel corresponding to the key of the Keyboard format comprises:
setting a picture displayed on the touch panel corresponding to the key of the Keyboard format.

6. The key setting method of claim 1 further comprising a step of:
entering a key setting mode to perform the step of selecting a Keyboard format.

7. The key setting method of claim 1, wherein the electronic device is a portable electronic device.

8. The key setting method of claim 1, wherein the electronic device is a mobile phone, a smart phone, a personal digital assistant (PDA), or a tablet computer.

9. An electronic device, comprising:
a touch panel;
a Keyboard format selecting module, which provides a plurality of options of different Keyboard formats to be selected via the touch panel, wherein each of the Keyboard formats has at least one key;
a key pattern setting module, which provides a plurality of options of different patterns to be selected corresponding to the key in the Keyboard format via the touch panel; and
a storing module, which stores settings related to the Keyboard format and the key.

10. The electronic device of claim 9, wherein the Keyboard format is a numeral Keyboard format, a character Keyboard format, a direction Keyboard format, a game Keyboard format, a calculator Keyboard format, or a compound Keyboard format.

11. The electronic device of claim 9, wherein the key pattern setting module provides a plurality of options of different texture patterns to be selected corresponding to the key in the Keyboard format via the touch panel.

12. The electronic device of claim 9, wherein the key pattern setting module provides a plurality of options of different color patterns to be selected corresponding to the key in the Keyboard format via the touch panel.

13. The electronic device of claim 9, wherein the key pattern setting module provides a plurality of options of different pictures to be selected corresponding to the key in the Keyboard format via the touch panel.

14. The electronic device of claim 9, wherein the electronic device enters a key setting mode for the touch panel to display the options of the Keyboard formats.

15. The electronic device of claim 14, wherein the touch panel shows the options of the patterns for the key in the Keyboard format after one of the Keyboard formats is selected.

16. The electronic device of claim 9, wherein the electronic device is a portable electronic device.

17. The electronic device of claim 9, wherein the electronic device is a mobile phone, a smart phone, a personal digital assistant (PDA), or a tablet computer.
